(19) United States
(12) Patent Application Publication
(10) Pub. No.: US 2024/0373279 A1
(43) Pub. Date: Nov. 7, 2024

(54) First Node, Second Node, Third Node Communications System and Methods Performed Thereby for Handling Provision of a Service to a Device

(71) Applicant: Telefonaktiebolaget LM Ericsson (publ), Stockholm (SE)

(72) Inventors: Susana Fernandez Alonso, Madrid (ES); Jingrui Tao, Guangzhou (CN); Ping Chen, Shanghai (CN); Emiliano Merino Vazquez, Madrid (ES)

(21) Appl. No.: 18/291,613

(22) PCT Filed: Oct. 19, 2021
(86) PCT No.: PCT/EP2021/078951

§ 371 Date: Jan. 24, 2024

(30) Foreign Application Priority Data
Jul. 26, 2021 (EP) 21382688.6

(51) Int. Cl. H04W 28/02; H04L 41/5003

(52) U.S. Cl. CPC H04W 28/0268; H04L 41/5003

(57) ABSTRACT

A method performed by a first node (111), for handling provision of a service to a device (130). The first node (111) receives (301) a request from a second node (112) operating in the communications system (100). The request requests an authorization for the provision of the service with a first quality of service (QoS), and for provision of the service with one or more alternative qualities of service (QoSs). The request further requests a bit rate associated to each of the first QoS and the one or more alternative QoSs. The first node (111) determines (302) one or more allowed QoSs, amongst the first QoS and the one or more alternative QoSs, and, for each allowed QoS, an associated bit rate. The first node (111) then sends (303) a response to the second node (112) to the received request. The response indicates the one or more allowed QoSs and the respectively associated bit rate.

### TECHNICAL FIELD

The present disclosure relates generally to a first node and methods performed thereby for handling provision of a service to a device. The present disclosure also relates generally to a second node, and methods performed thereby, for handling provision of the service to the device. The present disclosure also relates generally to a third node, and methods performed thereby for handling provision of the service to the device. The present disclosure further relates generally to a communications system and methods performed thereby for handling provision of the service to the device.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-UTRA, as well as a Fifth Generation (5G) Packet Core Network, which may be referred to as 5G Core Network (5GC), abbreviated as 5GC.

A 3GPP system comprising a 5G Access Network (AN), a 5GC and a UE may be referred to as a 5G system.

FIG. 1 is a schematic diagram depicting a particular example of a 5G reference architecture as defined by 3GPP, which may be used as a reference for the present disclosure. An Application Function (AF) 1 may provide a service in the communications system and may interact with the 3GPP Core Network through a Network Exposure Function (NEF) 2. In case the AF 1 is trusted, e.g., internal to the network operator, the AF may interact with the 3GPP Core Network directly, with no NEF 2 involved. The NEF 2 may support different functionality, e.g., different Exposure Application Program Interfaces (APIs). The Unified Data Repository (UDR) 3 may store data grouped into distinct collections of subscription-related information: subscription data, policy data, structured data for exposure, and application data. The Charging Function (CHF) 4 may support charging related functionality, specifically online and offline charging. The Policy Control Function (PCF) 5 may support a unified policy framework to govern the network behavior. Specifically, the PCF 5 may provide Policy and Charging Control (PCC) rules to the Policy and Charging Enforcement Function (PCEF), that is, the Session Management Function (SMF)/User Plane function (UPF) that may enforce policy and charging decisions according to provisioned Policy and Charging Control (PCC) rules. The Session Management Function (SMF) 6 may support different functionalities, e.g., may receive PCC rules from the PCF 5 and may configure the UPF 7 accordingly. The UPF 7 may support handling of user plane traffic based on the rules received from the SMF 6, e.g. packet inspection and different enforcement actions such as reporting for charging and Quality of Service (QOS) handling. The PCF 5 may provide policy rules to a UE through the Access and Mobility Function (AMF) 8. The AMF 8 may manage access of the UE. For example, when the UE may be connected through different access networks, and mobility aspects of the UE. Also depicted in FIG. 1 is a Network Data Analytics Function (NWDAF) 9. Each of the UDR 3, the NEF 2, the NWDAF 9, the AF 1, the PCF 5, the CHF 4, the AMF 8, the SMF 6 and the UPF 7 may have an interface through which they may be accessed, which as depicted in the Figure, may be, respectively: Nudr 10, Nnef 11, Nnwdaf 12, Naf 13, Npcf 14, Nchf 15, Namf 16, Nsmf 17 and N4 18.

A given AF may request that, in order to provide a service to a device, an AF session be applied a certain QoS, that is, the best possible QoS. In addition to the best possible QoS, 3GPP TS 23.503, in “Policy and charging control framework for the 5G System (5GS); Stage 2”, has specified that an AF may request an alternative QoS via a NEF. This may be understood to mean that, if the optimal QoS requested cannot be applied, the network should try to apply the next, alternative, QoS in priority order. To illustrate this, a typical use case scenario may be considered of a video streaming application managed by an AF. Before starting to send video to a certain UE, the AF may request that the 5GC network apply a given QoS reference, which may be associated to a bit rate, e.g., for high-definition video, and, if there is no possibility for such QoS to be applied, it may provide alternative QoS references, e.g., for medium and/or low video quality. That is, the AF may try to offer the best QoS to the UE, and request, as fallback options, lower QoSs, in the event the 5GC cannot offer the requested, higher QoS to the UE in order to facilitate provision of the service offered by the AF.

Existing methods to provide services in a network according to the foregoing, may result in wasted resources, traffic overload, long latencies, and reduced capacity, leading therefore to a poor performance of the network for new QoS sessions since the capacity may be exhausted, and poor user experience.

### SUMMARY

As part of the development of embodiments herein, one or more challenges with the existing technology will first be identified and discussed.

According to existing methods, provision of a service, e.g., streaming of a video, in a network will be first attempted in the highest quality that has been requested by the provider of the service. For example, if the service is video streaming, if a user watching a video on his smartphone has a monthly data plan, e.g., to watch a video streaming application, he may want to select the video quality based on the estimated Gb consumed for the selected video quality, to manage consumption of his data quota. However, according to existing methods, the video streaming provider does not know which bit rate and/or QoS the network will grant based on the user's subscription, e.g., gold, silver or bronze. The user does not know either the data consumption associated to each video quality. If the user knew the data cost the streaming of the video with the highest quality would represent, the user may opt to stream the video with a lower quality than that granted by the network. This would not only enable the user to manage usage of his data quota based on his subscription, but it would also enable the network to manage his resources more efficiently, and lead to a better performance. Hence, by the highest QoS being consistently used, whenever allowed by the network, the usage of the resources of the network may be not optimal, and the network may be overloaded as a result, leading to a reduced capacity for new users, e.g., willing to use video streaming, higher latency, and poor performance.

According to the foregoing, it is an object of embodiments herein to improve the handling of provision of a service to a device in a communications system.

According to a first aspect of embodiments herein, the object is achieved by a computer-implemented method, performed by a first node. The method is for handling provision of a service to a device. The first node and the device operate in a communications system. The first node receives, a first request from a second node operating in the communications system. The first request requests an authorization for the provision of the service with a first quality of service (QOS), and for provision of the service with one or more alternative qualities of service (QoSs). The first request further requests a bit rate associated to each of the first QoS and the one or more alternative QoSs. The first node determines one or more allowed QoSs, amongst the first QoS and the one or more alternative QoSs, and, for each allowed QoS, an associated bit rate. The first node then sends a first response to the second node to the received first request. The first response indicates the one or more allowed QoSs and the respectively associated bit rate.

According to a second aspect of embodiments herein, the object is achieved by a computer-implemented method, performed by the second node. The method is for handling provision of the service to the device. The second node and the device operate in the communications system. The second node sends the first request to the first node operating in the communications system. The first request requests the authorization for the provision of the service with the first QoS, and for provision of the service with the one or more alternative QoSs. The first request further requests the bit rate associated to each of the first QoS and the one or more alternative QoSs. The second node then receives the first response from the first node to the sent first request. The first response indicates the one or more allowed QoSs, amongst the first QoS and the one or more alternative QoSs, and, for each allowed QoS, the respectively associated bit rate.

According to a third aspect of embodiments herein, the object is achieved by a computer-implemented method, performed by the third node. The method is for handling provision of the service to the device. The third node and the device operate in the communications system. The third node is a provider of the service. The third node sends, a previous request to the second node operating in the communications system. The previous request requests the authorization for the provision of the service with the first QoS, and for provision of the service with the one or more alternative QoSs. The first request further requests the bit rate associated to each of the first QoS and the one or more alternative QoSs. The third node also receives the second response from the second node to the sent previous request. The second response indicates the one or more allowed QoSs, amongst the first QoS and the one or more alternative QoSs, and, for each allowed QoS, the respectively associated bit rate.

According to a fourth aspect of embodiments herein, the object is achieved by a computer-implemented method, performed by the communications system. The method is for handling provision of the service to the device. The communications system comprises the first node, the second node and the third node. The third node is the provider of the service. The method comprises sending, by the third node, the previous request to the second node operating in the communications system. The previous request requests the authorization for the provision of the service with the first QoS, and for provision of the service with the one or more alternative QoSs. The first request further requests the bit rate associated to each of the first QoS and the one or more alternative QoSs. The method also comprises sending, by the second node, the first request to the first node operating in the communications system. The first request requests the authorization for the provision of the service with the first QoS, and for provision of the service with the one or more alternative QoSs. The first request further requests the bit rate associated to each of the first QoS and the one or more alternative QoSs. The method then comprises receiving, by the first node, the first request from the second node. The method also comprises determining, by the first node, the one or more allowed QoSs, amongst the first QoS and the one or more alternative QoSs, and, for each allowed QoS, an associated bit rate. The method also comprises sending, by the first node, the first response to the second node to the received first request, the first response indicating the one or more allowed QoSs and the respectively associated bit rate. The method additionally comprises receiving, by the second node, the first response from the first node. The method further comprises receiving, by the third node, the second response from the second node to the sent previous request. The second response indicates the one or more allowed QoSs, amongst the first QoS and the one or more alternative QoSs, and, for each allowed QoS, the respectively associated bit rate.

According to a fifth aspect of embodiments herein, the object is achieved by the first node, for handling provision of the service to the device. The first node and the device are configured to operate in the communications system. The first node is further configured to receive, the first request from the second node configured to operate in the communications system. The first request is configured to request the authorization for the provision of the service with the first QoS, and for provision of the service with the one or more alternative QoSs. The first request is further configured to request the bit rate configured to be associated to each of the first QoS and the one or more alternative QoSs. The first node is also configured to determine the one or more allowed QoSs, amongst the first QoS and the one or more alternative QoSs, and, for each allowed QoS, an associated bit rate. The first node is further configured to send the first response to the second node to the first request configured to be received. The first response is configured to indicate the one or more allowed QoSs and the respectively associated bit rate.

According to a sixth aspect of embodiments herein, the object is achieved by the second node, for handling provision of the service to the device. The second node and the device are configured to operate in the communications system. The second node is further configured to send the first request to the first node configured to operate in the communications system. The first request is configured to request the authorization for the provision of the service with the first QoS, and for provision of the service with the one or more alternative QoSs. The first request is further configured to request the bit rate configured to be associated to each of the first QoS and the one or more alternative QoSs. The second node is also configured to receive the first response from the first node to the first request configured to be sent. The first response is configured to indicate the one or more allowed QoSs, amongst the first QoS and the one or more alternative QoSs, and, for each allowed QoS, the respectively associated bit rate.

According to a seventh aspect of embodiments herein, the object is achieved by the third node, for handling provision of the service to the device. The third node and the device are configured to operate in the communications system. The third node is configured to be the provider of the service. The third node is further configured to send the previous request to the second node configured to operate in the communications system. The previous request is configured to request the authorization for the provision of the service with the first QoS and for provision of the service with the one or more alternative QoSs. The first request is further configured to request the bit rate configured to be associated to each of the first QoS and the one or more alternative QoSs. The third node is also configured to receive the second response from the second node to the previous request configured to be sent. The second response is configured to indicate the one or more allowed QoSs, amongst the first QoS and the one or more alternative QoSs, and, for each allowed QoS, the respectively associated bit rate.

According to an eighth aspect of embodiments herein, the object is achieved by the communications system, for handling provision of the service to the device. The communications system comprises the first node, the second node and the third node. The third node is configured to be the provider of the service. The communications system is further configured to send, by the third node, the previous request to the second node configured to operate in the communications system. The previous request is configured to request the authorization for the provision of the service with the first QoS, and for provision of the service with the one or more alternative QoSs. The first request is further configured to request the bit rate configured to be associated to each of the first QoS and the one or more alternative QoSs. The communications system is also configured to send, by the second node the first request to the first node configured to operate in the communications system. The first request is configured to request the authorization for the provision of the service with the first QoS, and for provision of the service with the one or more alternative QoSs. The first request is further configured to request the bit rate configured to be associated to each of the first QoS and the one or more alternative QoSs. The communications system is further configured to receive, by the first node, the first request from the second node. The communications system is additionally configured to determine, by the first node, the one or more allowed QoSs, amongst the first QoS and the one or more alternative QoSs, and, for each allowed QoS, the associated bit rate. The communications system is also configured to send, by the first node, the first response to the second node to the first request configured to be received. The first response is configured to indicate the one or more allowed QoSs and the respectively associated bit rate. The communications system is also configured to receive, by the second node, the first response from the first node. The communications system is further configured to receive, by the third node, the second response from the second node to the previous request configured to be sent. The second response is configured to indicate the one or more allowed QoSs, amongst the first QoS and the one or more alternative QoSs, and, for each allowed QoS, the respectively associated bit rate.

By receiving the first request from the second node, which may be understood to be based on the previous request, the third node, e.g., an application, such as for example a video streaming application, may request which may be the authorized QoS and the associated granted bit rate allocated and/or provisioned for a user of the device, so that any authorized QoSs may be ultimately indicated to the device with any associated bit rates, and the user of the device may then select with which authorized QoS it may wish to obtain the service.

By determining the one or more allowed QoSs and, for each allowed QoS, the associated bit rate, the first node may be enabled to then provide this information towards the third node, so that the third node may be enabled to ultimately provide this information to the device. Thereby, the different options, e.g., different video qualities, may be presented in advance to the user of the device to allow the user to be aware of the data consumption before selecting an appropriate QoS.

By sending the first response, the first node may enable the third node to calculate the user's consumption from his data plan for each of the authorized QoSs, and ultimately enable the third node to display the information to the user, so that the user may make an informed decision and select the appropriate QoS, e.g., video quality.

As a consequence, the resources of the communications system may be used more efficiently, so that the latency of the communications system may be reduced, the capacity may be increased, and the performance of the communications system may be increased, thereby improving the user's experience with the communications system.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a 5G Network Architecture.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a flowchart depicting embodiments of a method in a third node, according to embodiments herein.

FIG. 6 is a flowchart depicting embodiments of a method in a communications system, according to embodiments herein.

FIG. 7 is a schematic diagram depicting a non-limiting example of signalling between nodes in a communications system, according to embodiments herein.

FIG. 8 is a schematic block diagram illustrating two non-limiting examples, a) and b), of a first node, according to embodiments herein.

FIG. 9 is a schematic block diagram illustrating two non-limiting examples, a) and b), of a second node, according to embodiments herein.

FIG. 10 is a schematic block diagram illustrating two non-limiting examples, a) and b), of a third node, according to embodiments herein.

FIG. 11 is a schematic block diagram illustrating two non-limiting examples, a) and b), of a communications system, according to embodiments herein.

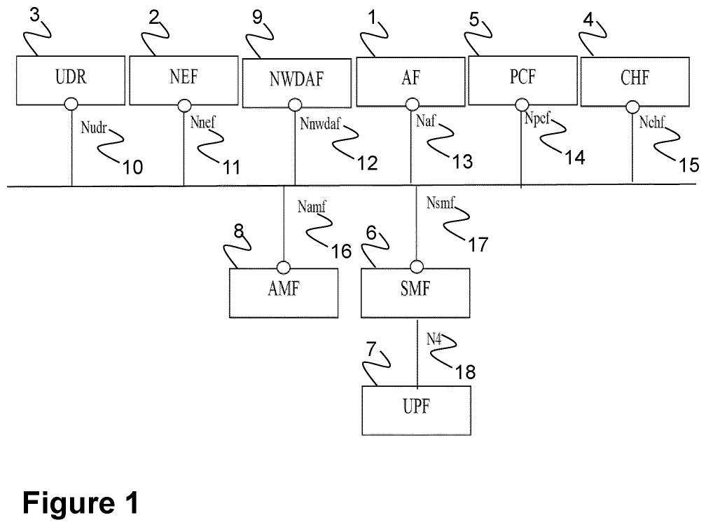

### DETAILED DESCRIPTION

Certain aspects of the present disclosure and their embodiments address one or more of the challenges identified with the existing methods and provide solutions to the challenges discussed.

As a summarized overview, embodiments herein may be understood to comprise a method whereby, as an example, an AF, when creating the AF session with QoS, may request authorization information, so that the network, e.g., a PCF via a NEF to the AF, may return which alternative QoS references may be authorized for the UE, in addition to the main QoS requested. The AF may also request the bit rate that may be associated to each authorized alternative QoS reference, so that it may be aware of the bit rate associated to each QoS video quality, e.g., high, medium and/or low. In particular examples wherein the involved nodes may be the PCF, the NEF and the AF, the NEF may forward the indications of authorized alternative QoS, and bit rate requested to the PCF. When the policies may be evaluated, the PCF may return to the NEF/AF those authorized alternative QoS and the bit rate associated to each authorized QoS. Additionally, the PCF may also return the validity of such authorization, for example, in examples wherein there may be policies in a policy controller, such as e.g., a Policy and Charging Rules Function (PCRF), based on Time Of Day. The AF may then be enabled to calculate the user's consumption from his data plan, and display the information to the user, so that the user may make an informed decision and select the appropriate video quality.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

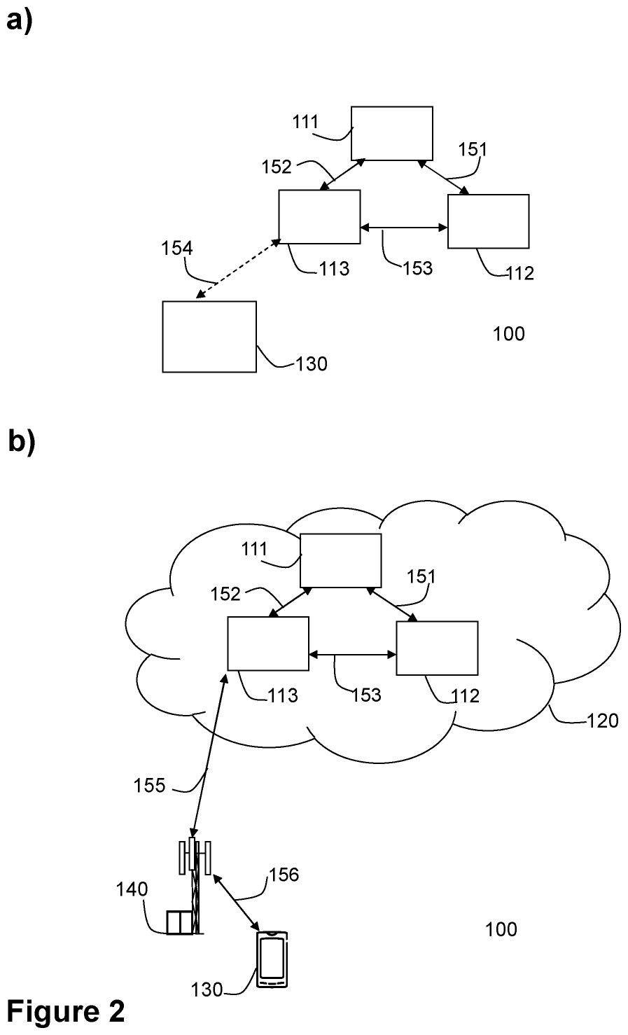

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. The telecommunications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, and a third node 113 are depicted in FIG. 2. Any of the first node 111, the second node 112 and the third node 113 may be understood, respectively, as a first computer system, a second computer system and a third computer system. In some examples, any of the first node 111, the second node 112 and the third node 113 may be implemented as a standalone server in e.g., a host computer in the cloud 120, as depicted in the non-limiting example depicted in panel b) of FIG. 2. Any of the first node 111, the second node 112 and the third node 113 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112 and the third node 113 may also be implemented as processing resources in a server farm.

In some embodiments, any of the first node 111, the second node 112 and the third node 113 may be independent and separated nodes. In some embodiments, the first node 111 and the second node 112 may be one of: co-localized and the same node. All the possible combinations are not depicted in FIG. 2 to simplify the Figure.

It may be understood that the communications system 100 may comprise more nodes than those represented on panel a) of FIG. 2.

In some examples of embodiments herein, the first node 111 may be understood as a node having a capability to manage provision of resources in the communications system 100 for provision of a service to a device, such as the device 130 described below. Provision of the resources, e.g., a QoS, may be performed according to one or more rules or policies of the communications system 100, applicable to the device 130 for provision of the service. Non-limiting examples of the first node 111 may be a PCF.

The second node 112 may be a node having a capability to enable interaction of an AF providing a service in the communications system 100 such as the third node 113 with a core network of the communications system 100. The second node 112 may support different functionality, e.g., different Exposure Application Program Interfaces (APIs). In particular examples, the second node 112 may be a NEF.

The third node 113 may be a node having a capability to provide a service to a device, such as the device 130, in the communications system 100. In some particular examples, the third node 113 may be an AF, e.g., in a 5G network.

The communications system 100 may comprise a plurality of devices whereof a device 130 is depicted in FIG. 2. The device 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 2b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the third node 113 over a second link 152, e.g., a radio link or a wired link. The third node 113 may communicate, directly or indirectly, with the second node 112 over a third link 153, e.g., a radio link or a wired link. The third node 113 may communicate, directly or indirectly, with the device 130 over a fourth link 154, e.g., a radio link or a wired link. The third node 113 may communicate, directly or indirectly with the radio network node 140 over a fifth link 155, e.g., a radio link or a wired link. The radio network node 140 may communicate with the device 130 over a sixth link 156, e.g., a radio link. Any of the first link 151, the second link 152, the third link 153, the fourth link 154, the fifth link 155 and/or the sixth link 156 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, “third”, “fourth”, “fifth” and/or “sixth” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies. For example, although the examples of embodiments herein may be described in the context of a 5G network architecture, the same mechanisms may be applied to a 4G network, just by replacing PCF by PCRF and NEF by Service Capability Exposure Functions (SCEF).

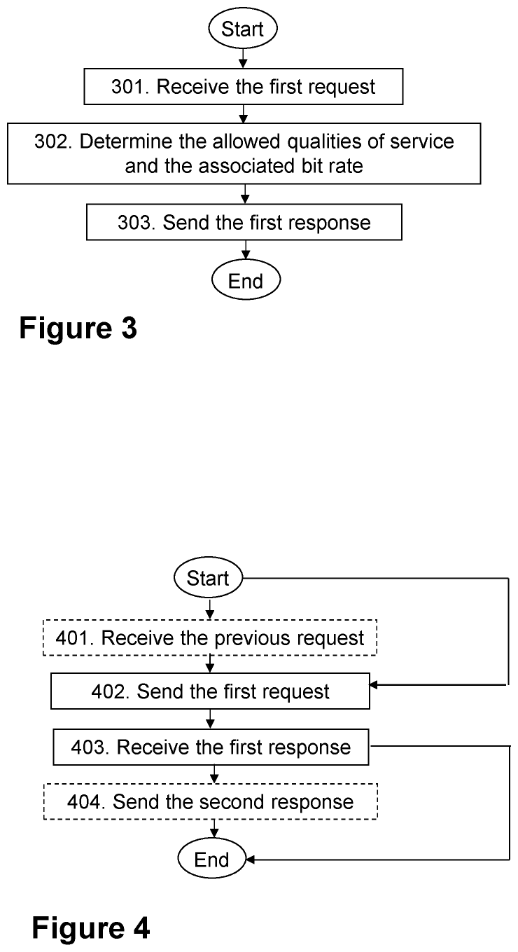

Embodiments of a computer-implemented method, performed by the first node 111, will now be described with reference to the flowchart depicted in FIG. 3. The method may be understood to be for handling provision of a service to the device 130. The first node 111 and the device 130 operate in the communications system 100.

The method comprises the actions described below. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

### Action 301

During the course of operations in the communications system 100, the device 130 may wish to obtain a service, e.g., streaming of a film, from the third node 113. The third node 113 may be understood to be a provider of the service. In particular examples, the third node 113 may be an AF. In order to provide the service to the device 130, the third node 113 may have created a session, e.g., a data session. The third node 113 may have created the session with a certain quality of service (QOS), e.g., a certain video quality, e.g., high, medium and/or low. When creating the session with the QoS, the third node 113 may request authorization for the QoS from the communications system 100. According to embodiments herein, the third node 113 may further request authorization for alternative qualities of service (QoSs), so that the communications system 100, may return which of the indicated QoSs may be authorized for the device 130, in addition to the main QoS requested. The node responsible for evaluating whether or not such authorization should be granted may be understood to be the first node 111, e.g., a PCF.

According to the foregoing, in this Action 301, the first node 111 receives a first request from the second node 112 operating in the communications system 100. The second node 112 may be a NEF. The first request may originate from the third node 113 operating in the communications system 100. The first request may therefore be received indirectly from the third node 113, via the second node 112.

The receiving of the first request may be performed e.g., via the second link 152.

The first request requests an authorization for the provision of the service with a first QoS, and for provision of the service with one or more alternative qualities of service (QoSs). The first request may be understood to be a default QoS. The one or more alternative QoSs may be understood as two additional QoSs, with which the first node 111 may be ready to provide the service to the device 130, should the first node 111 were to authorize its use, and the device 130 were to be interested. In order to ultimately be able to provide the information to the device 130, so that the device 139 may consider the information in making a choice about the QoS with which it may desire to receive the service, the first request further requests a bit rate associated to each of the first QoS and the one or more alternative QoSs, so that it may be aware of the bit rate associated to each QoS.

In some examples, the first request may be an AF Policy Authorization request.

As opposed to the existing methods, the one or more alternative QoSs may be higher than the first QoS.

By receiving the first request, an application, e.g., a video streaming application, may be enabled to request which may be the authorized QoS and the associated granted bit rate allocated and/or provisioned for the user, so that any authorized QoSs may be ultimately indicated to the device 130 by the third node 113 with any associated bit rates, so that the user of the device 130 may select with which authorized QoS it may wish to obtain the service.

### Action 302

In this Action 302, the first node 111 determines one or more allowed QoSs, amongst the first QoS and the one or more alternative QoSs, and, for each allowed QoS, an associated bit rate.

Determining may be understood as calculating or deriving.

The first node 111 may perform the determining in this Action 302 based on one or more policies and/or rules, applicable to the device 130 and/or to the service, based e.g., on the subscription of the device 130.

By determining the one or more allowed QoSs and, for each allowed QoS, the associated bit rate in this Action 302, the first node 111 may be enabled to then provide this information towards the third node 113, so that the third node 113 may be enabled to ultimately provide this information to the device 130, so the different options, e.g., different video qualities, may be presented in advance to allow the user to be aware of the data consumption before selecting an appropriate QoS.

### Action 303

In this Action 303, the first node 111 sends a first response, to the second node 112, to the received first request. The first response indicates the one or more allowed QoSs and the respectively associated bit rate.

The sending of the first response may be performed e.g., via the second link 152.

The sent first response may further indicate a validity of the first response.

In some embodiments, at least one of the following may apply. In some embodiments, the first request may originate from a third node 113 operating in the communications system 100 the third node 113 being the provider of the service. In some embodiments, the first response may be sent towards the third node 113, via the second node 112.

In some examples, the first response may be an AF Policy Authorization response.

By sending the first response in this Action 303, the first node 111 may enable the third node 113 to calculate the user's consumption from his data plan for each of the authorized QoSs and enable the third node 113 ultimately display the information to the user, so that the user may make an informed decision and select the appropriate QoS, e.g., video quality.

Embodiments of a computer-implemented method performed by the second node 112, will now be described with reference to the flowchart depicted in FIG. 4. The method may be understood to be for handling provision of the service to the device 130. The second node 112 and the device 130 operate in the communications system 100.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, the first node 111 may be a PCF, the second node 112 may be a NEF and the third node 113 may be an AF.

### Action 401

In this Action 401, the second node 112 may receive a previous request from the third node 113 operating in the communications system 100. The third node 113 is the provider of the service. The previous request may request the authorization for the provision of the service with the first QoS and for provision of the service with the one or more alternative QoSs. The previous request may further request the bit rate associated to each of the first QoS and the one or more alternative QoSs.

As mentioned earlier, the third node 113 may be, e.g., the AF.

The receiving of the previous request may be performed e.g., via the third link 153.

In some examples, the previous request may be an AF Session with QoS request.

### Action 402

The second node 112 may forward the requested authorization from the third node 113 and the request for the associated bit rate to the first node 111. Accordingly, in this Action 402, the second node 112 sends the first request to the first node 111 operating in the communications system 100. The first request requests the authorization for the provision of the service with the first QoS, and for provision of the service with the one or more alternative QoSs. The first request further requests the bit rate associated to each of the first QoS and the one or more alternative QoSs.

The one or more alternative QoSs may be higher than the first QoS.

The sending of the first request may be performed e.g., via the first link 151.

In some examples, the first request may be an AF Policy Authorization request.

### Action 403

The second node 112, in this Action 403, may receive the first response from the first node 111 to the sent first request. The first response indicates the one or more allowed QoSs, amongst the first QoS and the one or more alternative QoSs, and, for each allowed QoS, a respectively associated bit rate.

The receiving of the first response may be performed e.g., via the first link 151.

In some embodiments, the received first response may further indicate the validity of the first response.

In some examples, the first response may be an AF Policy Authorization response.

### Action 404

In this Action 404, the second node 112 may send the second response to the third node 113 to the received previous request. The second response may indicate the one or more allowed QoSs, amongst the first QoS and the one or more alternative QoSs, and, for each allowed QoS, the respectively associated bit rate.

The sending, of the second response may be performed, e.g., via the third link 153.

In some examples, the second response may be an AF Policy Authorization response.

The sent second response may further indicate the validity of the sent second response.

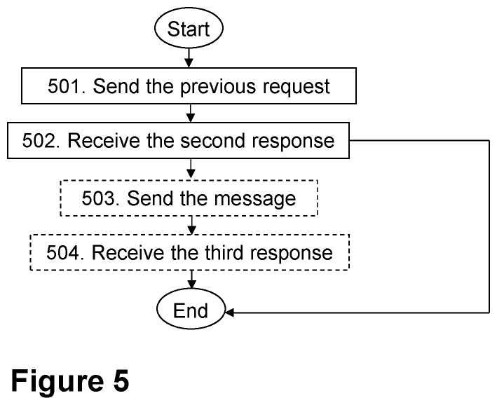

Embodiments of a computer-implemented method performed by the third node 113, will now be described with reference to the flowchart depicted in FIG. 5. The method may be understood to be for handling provision of the service to the device 130. The third node 113 and the device 130 operate in the communications system 100. The third node 113 is the provider of the service.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are depicted with dashed lines.

The detailed description of some of the following corresponds to the same references provided above, in relation to the actions described for the first node 111 and will thus not be repeated here to simplify the description. For example, the first node 111 may be a PCF, the second node 112 may be a NEF and the third node 113 may be an AF.

### Action 501

In this Action 501, the third node 113 sends the previous request to the second node 112 operating in the communications system 100. The previous request requests the authorization for the provision of the service with the first QoS, and for provision of the service with the one or more alternative QoSs. The first request further requests the bit rate associated to each of the first QoS and the one or more alternative QoSs.

The sending of the previous request may be performed e.g., via the third link 153.

### Action 502

In this Action 502, the third node 113 receives the second response from the second node 112 to the sent previous request. The second response indicates the one or more allowed QoSs, amongst the first QoS and the one or more alternative QoSs, and, for each allowed QoS, the respectively associated bit rate.

The one or more alternative QoSs may be higher than the first QoS.

The received second response may further indicate the validity of the sent second response.

### Action 503

In this Action 503, the third node 113 may send, based on the received second response, a message to the device 130. The message may request a selection of a QoS to provide the service to the device 130. The message may indicate the one or more allowed QoSs and, for each allowed QoS, the respectively associated bit rate. That is, the message may present to the device 130 the allowed QoSs for the provision of the service in the communications system 100, as well as the respectively associated bit rate, so that a user of the device 130 may be enabled to select the desired QoS, e.g., given the associated bit rate cost. This may enable to ensure that the resources of the communications system 100 that may be used to provide the service to the device 130 are those that have been requested by the device 130 and are not unnecessarily wasted, which may in turn ensure a more effective use of resources, and thereby enable an improved performance of the communications system 100. The latency of the communications system 100 may therefore be enabled to be shortened, the capacity increased, and the overall efficiency improved. The user experience may thereby also be improved.

### Action 504

In this Action 504, the third node 113 may receive a third response to the message from the device 130. The third response may indicate the selected QoS by the device 130.

By receiving the third response, the third node 113 may enable provision of the service to the device 130 with the selected QoS, which may in turn provide the same advantages just described for Action 503.

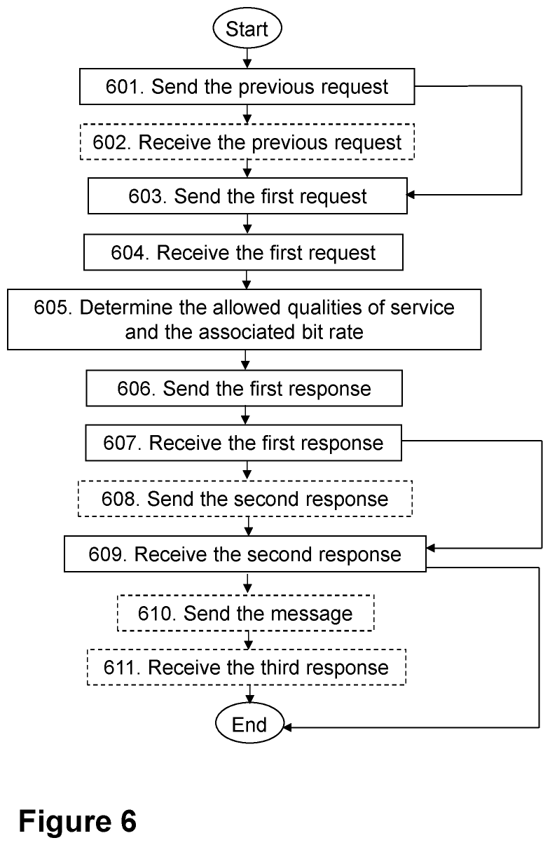

Embodiments of a computer-implemented method, performed by the communications system 100, will now be described with reference to the flowchart depicted in FIG. 6. The method may be understood to be for handling the provision of the service to the device 130. The first node 111 and the device 130 operate in the communications system 100. The communications system 100 comprises the first node 111, the second node 112, and the third node 113. As stated earlier, the third node 113 is the provider of the service.

The method may comprise the actions described below. In some embodiments some of the actions may be performed. In some embodiments all the actions may be performed. In FIG. 6, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, the first node 111 may be a PCF, the second node 112 may be a NEF and the third node 113 may be an AF.

### Action 601

This Action 601, which corresponds to Action 501, comprises, sending, by the third node 113, the previous request to the second node 112 operating in the communications system 100. The previous request requests the authorization for the provision of the service with the first QoS, and for provision of the service with the one or more alternative QoSs. The first request further requests the bit rate associated to each of the first QoS and the one or more alternative QoSs.

The one or more alternative QoSs may be higher than the first QoS.

### Action 602

In some embodiments, the method may comprise, in this Action 602, which corresponds to Action 401, comprises, receiving 401, by the second node 112, the previous request from the third node 113.

### Action 603

In this Action 603, which corresponds to Action 402, the method comprises, sending, by the second node 112 the first request to the first node 111 operating in the communications system 100. The first request requests the authorization for the provision of the service with the first QoS, and for provision of the service with the one or more alternative QoSs. The first request further requests the bit rate associated to each of the first QoS and the one or more alternative QoSs.

### Action 604

This Action 604, which corresponds to Action 301, comprises, receiving, by the first node 111, the first request from the second node 112.

### Action 605

In some embodiments, the method comprises, in this Action 605, which corresponds to Action 302, determining, by the first node 111, the one or more allowed QoSs, amongst the first QoSs and the one or more alternative QoSs, and, for each allowed QoS, the associated bit rate.

### Action 606

In some embodiments, the method comprises, in this Action 606, which corresponds to Action 303, sending, by the first node 111, the first response to the second node 112 to the received first request. The first response indicates the one or more allowed QoSs and the respectively associated bit rate.

The sent first response may further indicate the validity of the first response.

### Action 607

This Action 607, which corresponds to Action 403, comprises receiving, by the second node 112, the first response from the first node 111.

### Action 608

This Action 608, which corresponds to Action 404, may comprise sending, by the second node 112, the second response to the third node 113.

The sent second response may further indicate the validity of the sent second response.

### Action 609

This Action 609, which corresponds to Action 502, comprises, receiving, by the third node 113, the second response from the second node 112 to the sent previous request. The second response indicates the one or more allowed QoSs, amongst the first QoS and the one or more alternative QoSs, and, for each allowed QoS, the respectively associated bit rate.

### Action 610

This Action 610, which corresponds to Action 503, may comprise sending, by the third node 113, based on the received second response, the message to the device 130. The message may request the selection of the QoS to provide the service to the device 130. The message may indicate the one or more allowed QoSs and, for each allowed QoS, the respectively associated bit rate.

### Action 611

This Action 611, which corresponds to Action 504, may comprise, receiving, by the third node 113, the third response to the message from the device 130. The third response may indicate the selected QoS by the device 130.

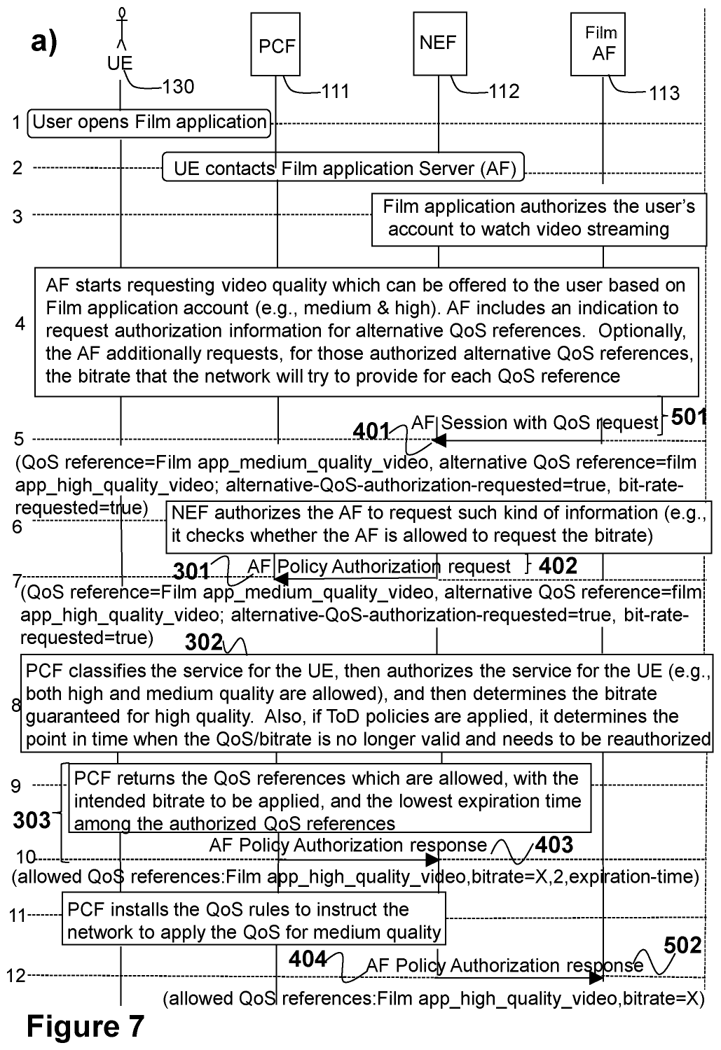

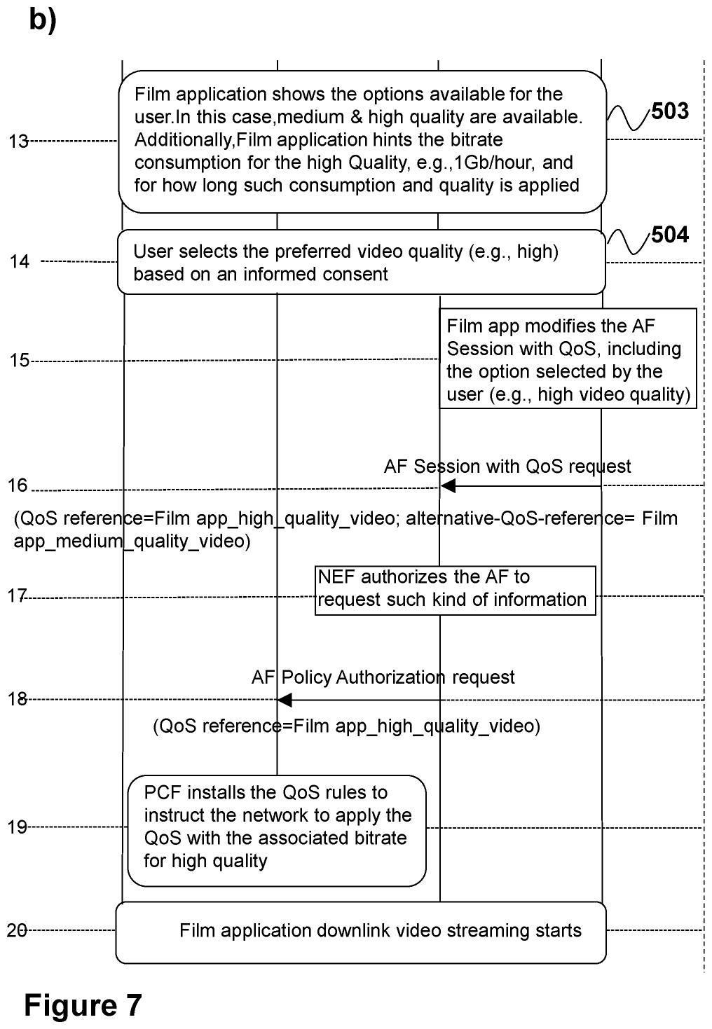

FIG. 7 is a signalling diagram depicting a non-limiting example of a method performed by the first node 111, the second node 112, the third node 113 and the device 130, according to embodiments herein. The method starts with the steps in panel a) and continues with the steps in panel b). In FIG. 7, the first node 111 is a PCF, the second node 112 is a NEF, the third node 113 is an AF providing a service for video streaming of films, and the device 130 is a UE. In Steps 1-3, a user of the device 130 logs in a video streaming application, or Film application. In Step 1, the user opens the film application. In Step 2, the UE contacts the third node 113, that is, the Film application Server (AF). In Step 3, the film application authorizes the user's account to watch video streaming. In Step 4, the third node 113, according to Action 501, starts requesting video quality which may be offered to the user based on the user's Film application account, e.g., medium and high. The third node 113 includes an indication to request authorization information for alternative QoS references. Optionally, the third node 113 additionally requests, for those authorized alternative QoS references, the bitrate that the network may try to provide for each QoS reference. In Step 5, the third node 113, that is, the Film AF, creates an AF session with QoS by sending the previous request including the lowest QoS as first QoS requested. In this example, this is the Film application, with a medium quality video. Additionally, the third node 113 includes an alternative QoS as the Film application, with a high quality video, and requests to be also informed about the authorization of the alternative QoS. The alternative-QoS-authorization-requested is therefore set to true. Also, the third node 113 requests the bit rate associated to the alternative authorized QoS. The bit-rate-requested is therefore also set to true. Particularly, the first request may indicate “QoS reference=Film app_medium_quality_video, alternative QoS reference=film app_high_quality_video; alternative-QoS-authorization-requested=true, bit-rate-requested=true”. The second node 112 receives the previous request according to Action 401. In step 6, the second node 112, before proxying the request to the first node 111, checks if the third node 113 is authorized to request, and receive, the bit rate for each QoS reference. The second node 112 authorizes the third node 113 to request such kind of information. In step 7, the second node 112 sends, according to Action 402, the first request to the first node 111 as an AF Policy Authorization request. The first node 111 receives the first request according to Action 301. In Step 8, in accordance with Action 302, the first node 111 evaluates any policies that may apply to the device 130 for provision of the service. The first node 111 classifies the service for the device 130, then authorizes the service for the device 130. For example, both high and medium quality are allowed. The first node 111 then determines the bitrate guaranteed for high quality. Also, if of Time of Day (ToD) policies are applied, it determines the point in time when the QoS and/or the bitrate is no longer valid and may need to be reauthorized. Since the authorization information was requested, and the bit rate was also requested, in Step 9 and Step 10, the first node 111 returns the alternative QoS which are authorized for the user and the related bit rate for each QoS, as well as the lowest expiration time among the authorized QoS references. The first node 111 sends the first response as an AF Policy Authorization response, which is received by the second node 112, according to Action 403. Particularly, the first response indicates “allowed QoS references: Film app_high_quality_video, bitrate=X,2, expiration-time”. In Step 11, the first node 111 installs the PCC rules in the SMF for the authorized QoS, particularly, for the medium QoS. In Step 12, the second node 112, in agreement with Action 404, sends the second response to the third node 113 as an AF Policy Authorization response. The third node 113 receives the second response in agreement with Action 502. Particularly, the second response indicates “allowed QoS references: Film app_high_quality_video, bitrate=X”. As continued in panel b), in Step 13, upon reception of the available or authorized QoS and the bit rate, the third node 113, in agreement with Action 503, displays to the user of the device 130 the video quality options with the estimated consumption. In this case, medium and high quality are available. Additionally, the third node 113 application hints the bitrate consumption for the high QoS, e.g., Gb consumed per hour for each video quality, and for how long such consumption and quality is applied. In Action 14, the user selects the highest video quality, e.g., the monthly data plan purchased by the user allows to consume still some more Gb and sends the third response to the third node 113, which receives it in accordance with Action 504. In Step 15, the third node 113 changes the AF session with QoS, including the option selected by the user e.g., high video quality, since the user is already aware of the bit rate selected. In Step 16, the third node 113, requests an AF session with the highest QoS request to the second node 112. The QoS reference is indicated as the high quality video, and the alternative QoS reference is indicated as the medium quality video. Particularly, the AF Policy Authorization requests indicates “QoS reference=Film app_high_quality_video”. In Step 17, the second node 112 authorizes the third node 113 to request such kind of information. In Step 18, the second node 112 sends an AF Policy Authorization request to the first node 111, indicating as QoS reference, the high quality video. In Step 19, the first node 111 installs the QoS rules to instruct the network to apply the QoS with the associated bitrate for high quality. In Step 20, the Film application downlink video streaming starts with the high-definition video streaming.

According to the foregoing, embodiments herein may therefore be understood to relate to early AF session with QoS control, e.g., QoS authorization. According to embodiments herein, an application, e.g., a video streaming application, may request the authorized QoS and the associated granted bit rate allocated and/or provisioned for the user, so the different options, e.g., different video qualities, may be presented in advance to allow the user to be aware of the data consumption before selecting an appropriate QoS.

Certain embodiments disclosed herein may provide one or more of the following technical advantage(s), which may be summarized as follows.

As a first advantage, embodiments herein may be understood to enable to provide the lowest QoS and alternative QoS, e.g., medium or high, so that they may not be established until the user may indeed select a medium quality QoS based on the informed data consumption, properties of the device 130, e.g., smartphone screen size, etc. . . . .

As another advantage, embodiments herein may be understood to enable to avoid that the user exhausts his/her monthly quota, e.g., watching high definition video without an informed decision.

As a further advantage, embodiments herein may be understood to allow applications to know about any bit rates that that may be allowed for the users, e.g., gold, silver, bronze, etc. . . . .

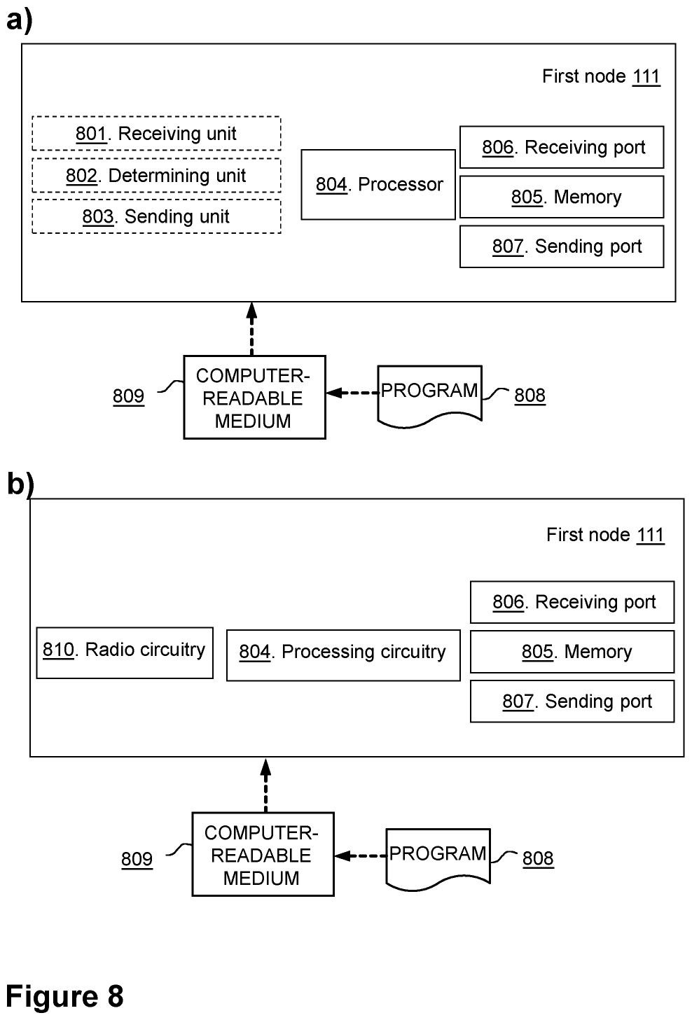

FIG. 8 depicts two different examples in panels a) and b), respectively, of the arrangement that the first node 111 may comprise to perform the method actions described above in relation to FIG. 3, and/or FIGS. 6-7. In some embodiments, the first node 111 may comprise the following arrangement depicted in FIG. 8a. The first node 111 may be understood to be for handling provision of the service to the device 130. The first node 111 and the device 130 are configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 8, optional boxes are indicated by dashed lines. The detailed description of some of the following corresponds to the same references provided above, in relation to the actions described for the first node 111 and will thus not be repeated here. For example, the first node 111 may be configured to be a PCF, the second node 112 may be configured to be a NEF and the third node 113 may be configured to be an AF.

The first node 111 is configured to, e.g. by means of a receiving unit 801 within the first node 111 configured to, receive, the first request from the second node 112 configured to operate in the communications system 100. The first request is configured to request the authorization for the provision of the service with the first QoS, and for provision of the service with the one or more alternative QoSs. The first request is further configured to request the bit rate configured to be associated to each of the first QoS and the one or more alternative QoSs.

The first node 111 is also configured to, e.g. by means of a determining unit 802 within the first node 111 configured to, determine the one or more allowed QoSs, amongst the first QoS and the one or more alternative QoSs, and, for each allowed QoS, the associated bit rate.

The first node 111 is further configured to, e.g. by means of a sending unit 803 within the first node 111 configured to, send the first response to the second node 112 to the first request configured to be received. The first response is configured to indicate the one or more allowed QoSs and the respectively associated bit rate.

In some embodiments, the one or more alternative QoSs may be configured to be higher than the first QoS.

In some embodiments, the first response configured to be sent may be further configured to indicate the validity of the first response.

In some embodiments, at least one of the following may apply. In some embodiments, the first request may be configured to originate from the third node 113 configured to operate in the communications system 100. The third node 113 may be configured to be the provider of the service. In some embodiments, the first response may be configured to be sent towards the third node 113, via the second node 112.

The embodiments herein may be implemented through one or more processors, such as a processor 804 in the first node 111 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 805 comprising one or more memory units. The memory 805 is arranged to be used to store obtained information, store data, configurations, schedulings, and applications etc. to perform the methods herein when being executed in the first node 111.

In some embodiments, the first node 111 may receive information from, e.g., the second node 112, the third node 113, the device 130, and/or another node through a receiving port 806. In some examples, the receiving port 806 may be, for example, connected to one or more antennas in the first node 111. In other embodiments, the first node 111 may receive information from another structure in the communications system 100 through the receiving port 806. Since the receiving port 806 may be in communication with the processor 804, the receiving port 806 may then send the received information to the processor 804. The receiving port 806 may also be configured to receive other information.

The processor 804 in the first node 111 may be further configured to transmit or send information to e.g., the second node 112, the third node 113, the device 130, and/or another node, another structure in the communications system 100, through a sending port 807, which may be in communication with the processor 804, and the memory 805.

Those skilled in the art will also appreciate that any of the units 801-803 described above may refer to a combination of analog and digital circuits, and/or one or more processors configured with software and/or firmware, e.g., stored in memory, that, when executed by the one or more processors such as the processor 804, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 801-803 described above may be the processor 804 of the first node 111, or an application running on such processor.

Thus, the methods according to the embodiments described herein for the first node 111 may be respectively implemented by means of a computer program 808 product, comprising instructions, i.e., software code portions, which, when executed on at least one processor 804, cause the at least one processor 804 to carry out the actions described herein, as performed by the first node 111. The computer program 808 product may be stored on a computer-readable storage medium 809. The computer-readable storage medium 809, having stored thereon the computer program 808, may comprise instructions which, when executed on at least one processor 804, cause the at least one processor 804 to carry out the actions described herein, as performed by the first node 111. In some embodiments, the computer-readable storage medium 809 may be a non-transitory computer-readable storage medium, such as a CD ROM disc, a memory stick, or stored in the cloud space. In other embodiments, the computer program 808 product may be stored on a carrier containing the computer program, wherein the carrier is one of an electronic signal, optical signal, radio signal, or the computer-readable storage medium 809, as described above.

The first node 111 may comprise an interface unit to facilitate communications between the first node 111 and other nodes or devices, e.g., the second node 112, the third node 113, the device 130, another node, and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 8b. The first node 111 may comprise a processing circuitry 804, e.g., one or more processors such as the processor 804, in the first node 111 and the memory 805. The first node 111 may also comprise a radio circuitry 810, which may comprise e.g., the receiving port 806 and the sending port 807. The processing circuitry 804 may be configured to, or operable to, perform the method actions according to FIG. 3, and/or FIGS. 6-7, in a similar manner as that described in relation to FIG. 8a. The radio circuitry 810 may be configured to set up and maintain at least a wireless connection with the second node 112, the third node 113, the device 130, another node, and/or another structure in the communications system 100.

Hence, embodiments herein also relate to the first node 111 operative for handling provision of the service to the device 130, the first node 111 and the device 130 being operative to operate in the communications system 100. The first node 111 may comprise the processing circuitry 804 and the memory 805, said memory 805 containing instructions executable by said processing circuitry 804, whereby the first node 111 is further operative to perform the actions described herein in relation to the first node 111, e.g., in FIG. 3, and/or FIGS. 6-7.

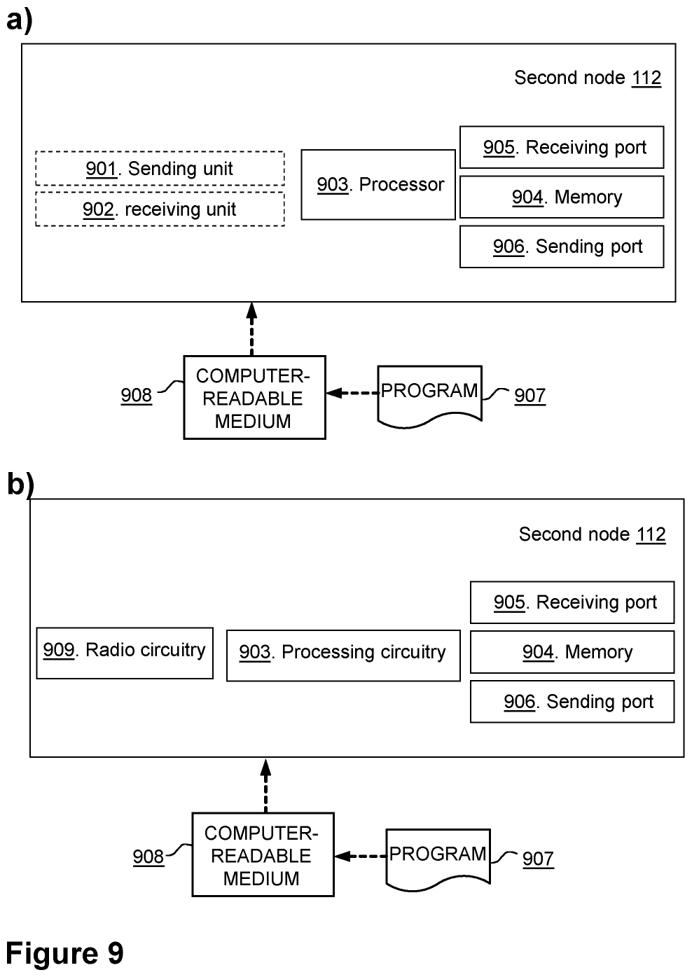

FIG. 9 depicts two different examples in panels a) and b), respectively, of the arrangement that the second node 112 may comprise to perform the method actions described above in relation to FIG. 4, and/or FIGS. 6-7. In some embodiments, the second node 112 may comprise the following arrangement depicted in FIG. 9a. The second node 112 may be understood to be for handling provision of the service to the device 130. The second node 112 and the device 130 are configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the second node 112 and will thus not be repeated here. For example, the first node 111 may be configured to be a PCF, the second node 112 may be configured to be a NEF and the third node 113 may be configured to be an AF.

The second node 112 is configured to, e.g. by means of a sending unit 901 within the second node 112 configured to, send the first request to the first node 111 configured to operate in the communications system 100. The first request is configured to request the authorization for the provision of the service with the first QoS, and for provision of the service with the one or more alternative QoSs. The first request may be further configured to request the bit rate configured to be associated to each of the first QoS and the one or more alternative QoSs.

The second node 112 is also configured to, e.g. by means of a receiving unit 902 within the second node 112 configured to, receive the first response from the first node 111 to the first request configured to be sent. The first response is configured to indicate the one or more allowed QoSs, amongst the first QoS and the one or more alternative QoSs, and, for each allowed QoS, the respectively associated bit rate.

In some embodiments, the one or more alternative QoSs may be configured to be higher than the first QoS.

In some embodiments, the first response configured to be received may be further configured to indicate the validity of the first response.

The second node 112 may also be configured to, e.g. by means of the receiving unit 902 within the second node 112 configured to, receive the previous request from the third node 113 configured to operate in the communications system 100. The third node 113 may be configured to be the provider of the service. The previous request may be configured to request the authorization for the provision of the service with the first QoS, and for provision of the service with the one or more alternative QoSs. The previous request may be further configured to request the bit rate configured to be associated to each of the first QoS and the one or more alternative QoSs.

In some embodiments, the second node 112 may be further configured to, e.g. by means of the sending unit 901 within the second node 112 configured to, send the second response to the third node 113 to the previous request configured to be received. The second response may be configured to indicate the one or more allowed QoSs, amongst the first QoS and the one or more alternative QoSs, and, for each allowed QoS, the respectively associated bit rate.

In some embodiments, the second response configured to be sent may be further configured to indicate the validity of the second response configured to be sent.

The embodiments herein may be implemented through one or more processors, such as a processor 903 in the second node 112 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 904 comprising one or more memory units. The memory 904 is arranged to be used to store obtained information, store data, configurations, schedulings, and applications etc. to perform the methods herein when being executed in the second node 112.

In some embodiments, the second node 112 may receive information from, e.g., the first node 111, the third node 113, the device 130, and/or another node, through a receiving port 905. In some examples, the receiving port 905 may be, for example, connected to one or more antennas in the second node 112. In other embodiments, the second node 112 may receive information from another structure in the communications system 100 through the receiving port 905. Since the receiving port 905 may be in communication with the processor 903, the receiving port 905 may then send the received information to the processor 903. The receiving port 905 may also be configured to receive other information.

The processor 903 in the second node 112 may be further configured to transmit or send information to e.g., the first node 111, the third node 113, the device 130, another node and/or another structure in the communications system 100, through a sending port 906, which may be in communication with the processor 903, and the memory 904.

Those skilled in the art will also appreciate that any of the units 901-902 described above may refer to a combination of analog and digital circuits, and/or one or more processors configured with software and/or firmware, e.g., stored in memory, that, when executed by the one or more processors such as the processor 903, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-902 described above may be the processor 903 of the second node 112, or an application running on such processor.

Thus, the methods according to the embodiments described herein for the second node 112 may be respectively implemented by means of a computer program 907 product, comprising instructions, i.e., software code portions, which, when executed on at least one processor 903, cause the at least one processor 903 to carry out the actions described herein, as performed by the second node 112. The computer program 907 product may be stored on a computer-readable storage medium 908. The computer-readable storage medium 908, having stored thereon the computer program 907, may comprise instructions which, when executed on at least one processor 903, cause the at least one processor 903 to carry out the actions described herein, as performed by the second node 112. In some embodiments, the computer-readable storage medium 908 may be a non-transitory computer-readable storage medium, such as a CD ROM disc, a memory stick, or stored in the cloud space. In other embodiments, the computer program 907 product may be stored on a carrier containing the computer program, wherein the carrier is one of an electronic signal, optical signal, radio signal, or the computer-readable storage medium 908, as described above.

The second node 112 may comprise an interface unit to facilitate communications between the second node 112 and other nodes or devices, e.g., the first node 111, the third node 113, the device 130, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 9b. The second node 112 may comprise a processing circuitry 903, e.g., one or more processors such as the processor 903, in the second node 112 and the memory 904. The second node 112 may also comprise a radio circuitry 909, which may comprise e.g., the receiving port 905 and the sending port 906. The processing circuitry 903 may be configured to, or operable to, perform the method actions according to FIG. 4, and/or FIGS. 6-7, in a similar manner as that described in relation to FIG. 9a. The radio circuitry 909 may be configured to set up and maintain at least a wireless connection with the first node 111, the third node 113, the device 130, another node and/or another structure in the communications system 100.

Hence, embodiments herein also relate to the second node 112 operative for handling provision of the service to the device 130, the second node 112 and the device 130 being operative to operate in the communications system 100. The second node 112 may comprise the processing circuitry 903 and the memory 904, said memory 904 containing instructions executable by said processing circuitry 903, whereby the second node 112 is further operative to perform the actions described herein in relation to the second node 112, e.g., in FIG. 4, and/or FIGS. 6-7.

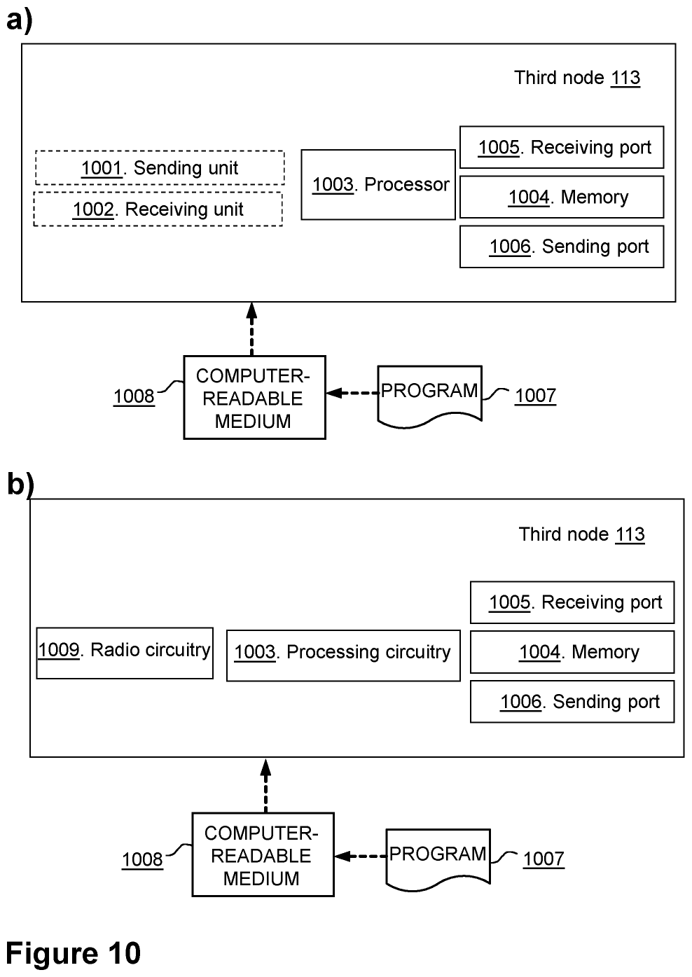

FIG. 10 depicts two different examples in panels a) and b), respectively, of the arrangement that the third node 113 may comprise to perform the method actions described above in relation to FIG. 6, FIG. 5 and/or FIG. 7. In some embodiments, the third node 113 may comprise the following arrangement depicted in FIG. 10a. The third node 113 may be understood to be for handling provision of the service to the device 130. The third node 113 and the device 130 are configured to operate in the communications system 100. The third node 113 is configured to be the provider of the service.

Several embodiments are comprised herein. Components from one embodiment may be tacitly assumed to be present in another embodiment and it will be obvious to a person skilled in the art how those components may be used in the other exemplary embodiments. In FIG. 10, optional boxes are indicated by dashed lines. The detailed description of some of the following corresponds to the same references provided above, in relation to the actions described for the third node 113 and will thus not be repeated here. For example, the first node 111 may be configured to be a PCF, the second node 112 may be configured to be a NEF and the third node 113 may be configured to be an AF.

The third node 113 is configured to, e.g. by means of a sending unit 1001 within the third node 113 configured to, send, the previous request to the second node 112 configured to operate in the communications system 100. The previous request may be configured to request the authorization for the provision of the service with the first QoS, and for provision of the service with the one or more alternative QoSs. The first request may be further configured to request the bit rate configured to be associated to each of the first QoS and the one or more alternative QoSs.

The third node 113 is also configured to, e.g. by means of a receiving unit 1002 within the third node 113 configured to, receive the second response from the second node 112 to the previous request configured to be sent. The second response is configured to indicate the one or more allowed QoSs, amongst the first QoS and the one or more alternative QoSs, and, for each allowed QoS, the respectively associated bit rate.

In some embodiments, the one or more alternative QoSs may be configured to be higher than the first QoS.

In some embodiments, the second response configured to be received may be further configured to indicate the validity of the second response configured to be received.

The third node 113 may be configured to, e.g. by means of the sending unit 1001 within the third node 113 configured to, send, based on the second response configured to be received, the message to the device 130. The message may be configured to request the selection of the QoS to provide the service to the device 130. The message may be also configured to indicate the one or more allowed QoSs and, for each allowed QoS, the respectively associated bit rate.

The third node 113 may be configured to, e.g. by means of the receiving unit 1002 within the third node 113 configured to, receive the third response to the message from the device 130. The third response may be configured to indicate the QoS configured to be selected by the device 130.

The embodiments herein may be implemented through one or more processors, such as a processor 1003 in the third node 113 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1004 comprising one or more memory units. The memory 1004 is arranged to be used to store obtained information, store data, configurations, schedulings, and applications etc. to perform the methods herein when being executed in the third node 113.

In some embodiments, the third node 113 may receive information from, e.g., the first node 111, the second node 112, the device 130, and/or another node, through a receiving port 1005. In some examples, the receiving port 1005 may be, for example, connected to one or more antennas in the third node 113. In other embodiments, the third node 113 may receive information from another structure in the communications system 100 through the receiving port 1005. Since the receiving port 1005 may be in communication with the processor 1003, the receiving port 1005 may then send the received information to the processor 1003. The receiving port 1005 may also be configured to receive other information.

The processor 1003 in the third node 113 may be further configured to transmit or send information to e.g., the first node 111, the second node 112, the device 130, another node, and/or another structure in the communications system 100, through a sending port 1006, which may be in communication with the processor 1003, and the memory 1004.

Those skilled in the art will also appreciate that the units 1001-1002 described above may refer to a combination of analog and digital circuits, and/or one or more processors configured with software and/or firmware, e.g., stored in memory, that, when executed by the one or more processors such as the processor 1003, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1001-1002 described above may be the processor 1003 of the third node 113, or an application running on such processor.

Thus, the methods according to the embodiments described herein for the third node 113 may be respectively implemented by means of a computer program 1007 product, comprising instructions, i.e., software code portions, which, when executed on at least one processor 1003, cause the at least one processor 1003 to carry out the actions described herein, as performed by the third node 113. The computer program 1007 product may be stored on a computer-readable storage medium 1008. The computer-readable storage medium 1008, having stored thereon the computer program 1007, may comprise instructions which, when executed on at least one processor 1003, cause the at least one processor 1003 to carry out the actions described herein, as performed by the third node 113. In some embodiments, the computer-readable storage medium 1008 may be a non-transitory computer-readable storage medium, such as a CD ROM disc, a memory stick, or stored in the cloud space. In other embodiments, the computer program 1007 product may be stored on a carrier containing the computer program, wherein the carrier is one of an electronic signal, optical signal, radio signal, or the computer-readable storage medium 1008, as described above.

The third node 113 may comprise an interface unit to facilitate communications between the third node 113 and other nodes or devices, e.g., the first node 111, the second node 112, the device 130, another node, and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 10b. The third node 113 may comprise a processing circuitry 1003, e.g., one or more processors such as the processor 1003, in the third node 113 and the memory 1004. The third node 113 may also comprise a radio circuitry 1009, which may comprise e.g., the receiving port 1005 and the sending port 1006. The processing circuitry 1003 may be configured to, or operable to, perform the method actions according to FIG. 5 and/or FIGS. 6-7, in a similar manner as that described in relation to FIG. 10a. The radio circuitry 1009 may be configured to set up and maintain at least a wireless connection with the first node 111, the second node 112, the device 130, another node, and/or another structure in the communications system 100.

Hence, embodiments herein also relate to the third node 113 operative for handling provision of the service to the device 130, the third node 113 and the device 130 being operative to operate in the communications system 100. The third node 113 may comprise the processing circuitry 1003 and the memory 1004, said memory 1004 containing instructions executable by said processing circuitry 1003, whereby the third node 113 is further operative to perform the actions described herein in relation to the third node 113, e.g., in FIG. 5 and/or FIGS. 6-7.

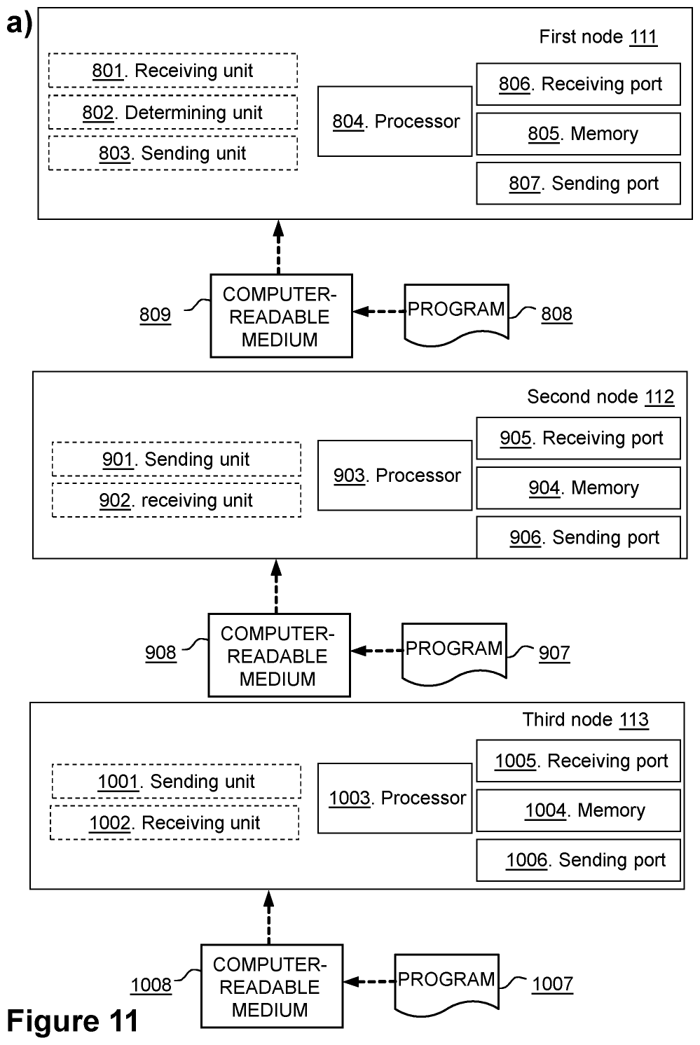

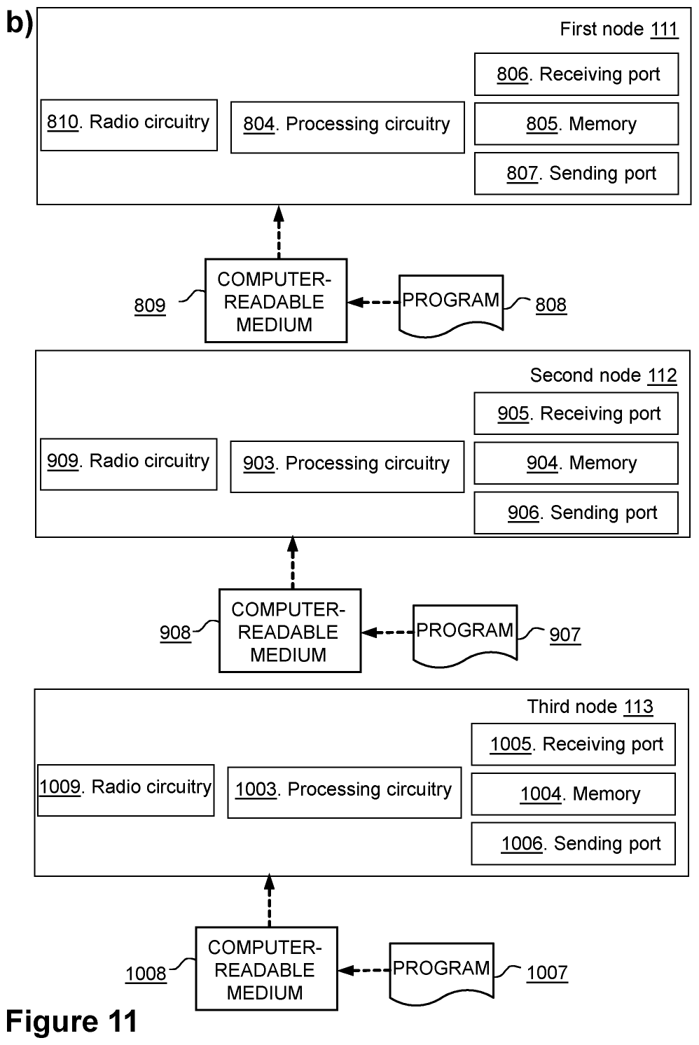

FIG. 11 depicts two different examples in panels a) and b), respectively, of the arrangement that the communications system 100 may comprise to perform the method actions described above in relation to FIG. 6 and/or FIG. 7. The arrangement depicted in panel a) corresponds to that described in relation to panel a) in FIG. 8, FIG. 9 and FIG. 10 for each of the first node 111, the second node 112 and the third node 113, respectively. The arrangement depicted in panel b) corresponds to that described in relation to panel b) in FIG. 8, FIG. 9 and FIG. 10 for each of the first node 111, the second node 112 and the third node 113, respectively. The communications system 100 may be for handling the provision of the service to the device 130. The communications system 100 is configured to comprise the first node 111, the second node 112 and the third node 113. The third node 113 is the provider of the service.

The communications system 100 is configured to, e.g. by means of the sending unit 1001 within the third node 113 configured to, send, by the third node 113, the previous request to the second node 112 configured to operate in the communications system 100. The previous request is configured to request the authorization for the provision of the service with the first QoS, and for provision of the service with the one or more alternative QoSs. The first request is further configured to request the bit rate configured to be associated to each of the first QoS and the one or more alternative QoSs.

The communications system 100 is also configured to, e.g. by means of the sending unit 901 within the second node 112 configured to, send, by the second node 112 the first request to the first node 111 configured to operate in the communications system 100. The first request is configured to request the authorization for the provision of the service with the first QoS, and for provision of the service with the one or more alternative QoSs. The first request is further configured to request the bit rate configured to be associated to each of the first QoS and the one or more alternative QoSs.

The communications system 100 is configured to, e.g. by means of the receiving unit 801 within the first node 111 configured to, receive, by the first node 111, the first request from the second node 112.

The communications system 100 is also configured to, e.g. by means of the determining unit 802 within the first node 111 configured to, determine, by the first node 111, the one or more allowed QoSs, amongst the first QoS and the one or more alternative QoSs, and, for each allowed QoS, the associated bit rate.

The communications system 100 is configured to, e.g. by means of the sending unit 803 within the first node 111 configured to, send, by the first node 111, the first response to the second node 112 to the first request configured to be received. The first response is configured to indicate the one or more allowed QoSs and the respectively associated bit rate.

The communications system 100 is also configured to, e.g. by means of the receiving unit 902 within the second node 112 configured to, receive, by the second node 112, the first response from the first node 111.

The communications system 100 is further configured to, e.g. by means of the receiving unit 1002 within the third node 113 configured to, receive, by the third node 113, the second response from the second node 112 to the previous request configured to be sent. The second response is configured to indicate the one or more allowed QoSs, amongst the first QoS and the one or more alternative QoSs, and, for each allowed QoS, the respectively associated bit rate.

In some embodiments, the one or more alternative QoSs may be configured to be higher than the first QoS.

In some embodiments, the first response configured to be sent may be further configured to indicate the validity of the first response.

The communications system 100 may be further configured to, e.g. by means of the receiving unit 902 within the second node 112 further configured to receive, by the second node 112, the previous request from the third node 113.

The communications system 100 is configured to, e.g. by means of the sending unit 901 within the second node 112 configured to, send, by the second node 112, the second response to the third node 113.

In some embodiments, the second response configured to be sent may be further configured to indicate the validity of the second response configured to be sent.

In some embodiments, the communications system 100 may be further configured to, e.g. by means of the sending unit 1001 within the third node 113 further configured to, send, by the third node 113, based on the second response configured to be received, the message to the device 130. The message may be configured to request the selection of the QoS to provide the service to the device 130. The message may be configured to indicate the one or more allowed QoSs and, for each allowed QoS, the respectively associated bit rate.

In some embodiments, the communications system 100 may be further configured to, e.g. by means of the receiving unit 1002 within the third node 113 further configured to, receive, by the third node 113, the third response to the message from the device 130. The third response may be configured to indicate the QoS configured to be selected by the device 130.

The remaining configurations described for the first node 111, the second node 112 and the third node 113 in relation to FIG. 11, may be understood to correspond to those described in FIG. 8, FIG. 9 and FIG. 10, respectively, and to be performed, e.g., by means of the corresponding units and arrangements described in FIG. 8, FIG. 9 and FIG. 10, which will not be repeated here.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1.-38. (canceled)

39. A computer-implemented method, performed by a first node, for handling provision of a service to a device, the first node and the device operating in a communications system, the method comprising:
receiving a first request from a second node operating in the communications system, the first request requesting an authorization for the provision of the service with a first quality of service (QOS) and for provision of the service with one or more alternative qualities of service (QOSs), wherein the first request further requests a bit rate associated to each of the first QoS and the one or more alternative QoSs;
determining one or more allowed QoSs, amongst the first QoS and the one or more alternative QoSs, and, for each allowed QoS, an associated bit rate; and
sending, to the second node, a first response to the received first request, the first response indicating the one or more allowed QoSs and the respectively associated bit rate.

40. The computer-implemented method according to claim 39, wherein the one or more alternative QoSs are higher than the first QoS.

41. The computer-implemented method according to claim 39, wherein the sent first response further indicates a validity of the first response.

42. The computer-implemented method according to claim 39, wherein at least one of:
the first request originates from a third node operating in the communications system, the third node being a provider of the service; and
the first response is sent towards the third node, via the second node.

43. A computer-implemented method, performed by a second node, for handling provision of a service to a device, the second node and the device operating in a communications system, the method comprising:
sending a first request to a first node operating in the communications system, the first request requesting an authorization for the provision of the service with a first quality of service (QOS) and for provision of the service with one or more alternative qualities of service (QoSs), wherein the first request further requests a bit rate associated to each of the first QoS and the one or more alternative QoSs,
receiving, from the first node, a first response to the sent first request, the first response indicating one or more allowed QoSs, amongst the first QoS and the one or more alternative QoSs, and, for each allowed QoS, a respectively associated bit rate.

44. The computer-implemented method according to claim 43, wherein the one or more alternative QoSs are higher than the first QoS.

45. The computer-implemented method according to claim 43, wherein the received first response further indicates a validity of the first response.

46. The computer-implemented method according to claim 43, wherein the method further comprises:
receiving a previous request from a third node operating in the communications system, the third node being a provider of the service, the previous request requesting the authorization for the provision of the service with the first QoS, and for provision of the service with the one or more alternative QoSs, wherein the previous request further requests the bit rate associated to each of the first QoS and the one or more alternative QoSs; and
sending a second response to the third node to the received previous request, the second response indicating the one or more allowed QoSs, amongst the first QoS and the one or more alternative QoSs, and, for each allowed QoS, the respectively associated bit rate.

47. The computer-implemented method according to claim 45, wherein the sent second response further indicates the validity of the sent second response.

48. A computer-implemented method, performed by a third node, for handling provision of a service to a device, the third node and the device operating in a communications system, the third node being a provider of the service, the method comprising:
sending a previous request to a second node operating in the communications system, the previous request requesting an authorization for the provision of the service with a first quality of service (QOS) and for provision of the service with one or more alternative qualities of service (QOSs), wherein the previous request further requests a bit rate associated to each of the first QoS and the one or more alternative QoSs; and
receiving, from the second node, a second response to the sent previous request, the second response indicating one or more allowed QoSs, amongst the first QoS and the one or more alternative QoSs, and, for each allowed QoS, a respectively associated bit rate.

49. The computer-implemented method according to claim 48, wherein the one or more alternative QoSs are higher than the first QoS.

50. The computer-implemented method according to claim 48, wherein the received second response further indicates a validity of the received second response.

51. The computer-implemented method according to claim 48, wherein the method further comprises:
sending, based on the received second response, a message to the device, the message requesting a selection of a QoS to provide the service to the device, the message indicating the one or more allowed QoSs and, for each allowed QoS, the respectively associated bit rate; and
receiving a third response to the message from the device, the third response indicating the selected QoS by the device.

52. A first node, for handling provision of a service to a device, the first node and the device being configured to operate in a communications system, the first node comprising processing circuitry configured to:
receive a first request from a second node configured to operate in the communications system, the first request requesting an authorization for the provision of the service with a first quality of service (QOS) and for provision of the service with one or more alternative qualities of service (QOSs), wherein the first request requests a bit rate associated to each of the first QoS and the one or more alternative QoSs;
determine one or more allowed QoSs, amongst the first QoS and the one or more alternative QoSs, and, for each allowed QoS, an associated bit rate; and
send, to the second node, a first response to the first request, the first response indicating the one or more allowed QoSs and the respectively associated bit rate.

53. The first node according to claim 52, wherein the one or more alternative QoSs are higher than the first QoS.

54. The first node according to claim 52, wherein the first response indicates a validity of the first response.

55. The first node according to claim 52, wherein at least one of:
the first request originates from a third node configured to operate in the communications system, the third node being configured to be a provider of the service; and
the first response is sent towards the third node, via the second node.
